(19) United States
(12) Patent Application Publication
(10) Pub. No.: US 2025/0365620 A1
(43) Pub. Date: Nov. 27, 2025

(54) COMMUNICATION OF USER EQUIPMENT LOCATION FOR HANDOVER PROCEDURES IN NON-TERRESTRIAL NETWORKS

(71) Applicant: QUALCOMM Incorporated, San Diego, CA (US)

(72) Inventors: Geetha Priya RAJENDRAN, Bangalore, Karnataka (IN); Bharat SHRESTHA, San Diego, CA (US); Prasad Reddy KADIRI, San Diego, CA (US); Luis Fernando Brisson LOPES, Swindon (GB)

(21) Appl. No.: 18/873,716

(22) PCT Filed: Aug. 4, 2023
(86) PCT No.: PCT/US2023/071749

§ 371 Date: Dec. 10, 2024

(30) Foreign Application Priority Data
Aug. 5, 2022 (IN) 202241044927

(51) Int. Cl. H04W 36/00; H04B 7/185

(52) U.S. Cl. CPC H04W 36/0005; H04B 7/18541

(57) ABSTRACT

In a non-terrestrial network (NTN), a user equipment (UE) may be configured to transmit location information associated with the UE to a source NTN entity. The UE may be further configured to perform a handover procedure from the source NTN entity to a target NTN entity after transmitting the location information to the source NTN entity. The UE may be further configured to refrain from transmitting the location information to the target NTN entity before completion of the handover procedure. The source NTN entity may be configured to receive UE location information, and transmit a message associated with handover of the UE to a target NTN entity, the message including information that is based on the UE location information.

### CROSS REFERENCE TO RELATED APPLICATION(S)

This application claims the benefit of Indian Provisional Application Ser. No. 202241044927, entitled “COMMUNICATION OF USER EQUIPMENT LOCATION FOR HANDOVER PROCEDURES IN NON-TERRESTRIAL NETWORKS” and filed on Aug. 5, 2022, the disclosure of which is expressly incorporated by reference herein in its entirety.

### BACKGROUND

### Technical Field

The present disclosure generally relates to communication systems, and more particularly, to signalling a user equipment (UE) location between network entities when the UE is being handed over between two network entities.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In a first aspect of the disclosure, a first method, a first computer-readable medium, and a first apparatus are provided. The first apparatus may be a user equipment (UE) or a component thereof. The first apparatus may be configured to transmit location information associated with the UE to a source non-terrestrial network (NTN) entity. The first apparatus may be further configured to perform a handover procedure from the source NTN entity to a target NTN entity after transmitting the location information to the source NTN entity. The first apparatus may be further configured to refrain from transmitting the location information to the target NTN entity before completion of the handover procedure.

In a second aspect of the disclosure, a second method, a second computer-readable medium, and a second apparatus are provided. The second apparatus may be a source NTN entity or a component thereof. The second apparatus may be configured to receive location information associated with a UE. The second apparatus may be further configured to transmit a message associated with handover of the UE to a target NTN entity, wherein the message includes information that is based on the location information. The second apparatus may be further configured to perform handover of the UE.

In a third aspect of the disclosure, a third method, a third computer-readable medium, and a third apparatus are provided. The third apparatus may be a target NTN entity or a component thereof. The third apparatus may be configured to receive a message associated with handover of a UE from a source NTN entity, wherein the message indicates location information associated with the UE. The third apparatus may be further configured to perform handover of the UE without requesting the location information from the UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink channels within a subframe, in accordance with various aspects of the present disclosure.

FIG. 3 is a diagram illustrating an example of a base station and user equipment (UE) in an access network.

FIG. 4 is a call flow diagram of an example procedure for handover of a UE during NTN-to-NTN mobility.

FIG. 5 is a call flow diagram of another example procedure for handover of a UE during NTN-to-NTN mobility.

FIG. 6 is a call flow diagram of still another example procedure for handover of a UE during NTN-to-NTN mobility.

FIG. 7 is a flowchart illustrating an example method at a UE for handover in an NTN.

FIG. 8 is a flowchart illustrating an example method at a source NTN entity for handover of a UE in an NTN.

FIG. 9 is a flowchart illustrating an example method at a target NTN entity for handover of a UE in an NTN.

FIG. 10 is a diagram illustrating an example of a hardware implementation for an example apparatus.

FIG. 11 is a diagram illustrating another example of a hardware implementation for another example apparatus.

FIG. 12 is a diagram illustrating a further example of a hardware implementation for a further example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, the concepts and related aspects described in the present disclosure may be implemented in the absence of some or all of such specific details. In some instances, well-known structures, components, and the like are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, computer-executable code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or computer-executable code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer-executable code in the form of instructions or data structures that can be accessed by a computer.

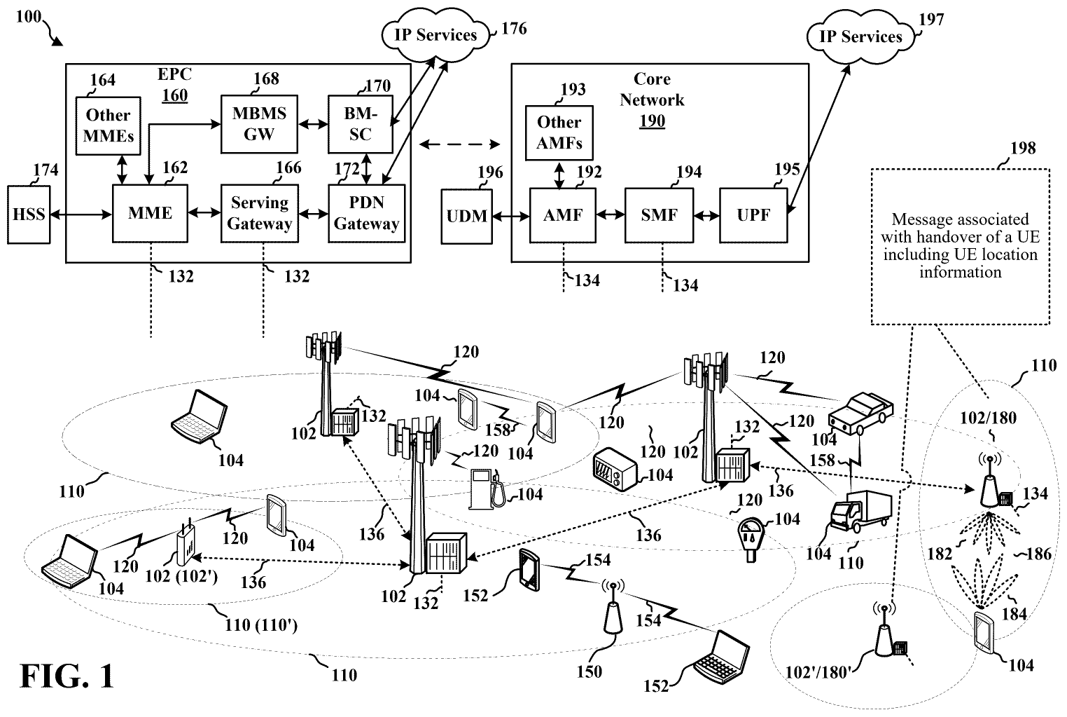

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR), which may be collectively referred to as Next Generation radio access network (RAN) (NG-RAN), may interface with core network 190 through second backhaul links 134.

In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, Multimedia Broadcast Multicast Service (MBMS), subscriber and equipment trace, RAN information management (RIM), paging, positioning, and delivery of warning messages.

In some aspects, the base stations 102 may communicate directly or indirectly (e.g., through the EPC 160 or core network 190) with each other over third backhaul links 136 (e.g., X2 interface). The first backhaul links 132, the second backhaul links 134, and the third backhaul links 136 may be wired, wireless, or some combination thereof. At least some of the base stations 102 may be configured for integrated access and backhaul (IAB). Accordingly, such base stations may wirelessly communicate with other base stations, which also may be configured for IAB.

At least some of the base stations 102 configured for IAB may have a split architecture that includes at least one of a central unit (CU), a distributed unit (DU), a radio unit (RU), a remote radio head (RRH), and/or a remote unit, some or all of which may be collocated or distributed and/or may communicate with one another. In some configurations of such a split architecture, a CU may implement some or all functionality of a radio resource control (RRC) layer, whereas a DU may implement some or all of the functionality of a radio link control (RLC) layer.

Illustratively, some of the base stations 102 configured for IAB may communicate through a respective CU with a DU of an IAB donor node or other parent IAB node (e.g., a base station), and further, may communicate through a respective DU with child IAB nodes (e.g., other base stations) and/or one or more of the UEs 104. One or more of the base stations 102 configured for IAB may be an IAB donor connected through a CU with at least one of the EPC 160 and/or the core network 190.

With such a connection to the EPC 160 and/or core network 190, a base station 102 operating as an IAB donor may provide a link to the EPC 160 and/or core network 190 for one or more UEs and/or other IAB nodes, which may be directly or indirectly connected (e.g., separated from an IAB donor by more than one hop) with the IAB donor. In the context of communicating with the EPC 160 or the core network 190, both the UEs and IAB nodes may communicate with a DU of an IAB donor. In some additional aspects, one or more of the base stations 102 may be configured with connectivity in an open RAN (ORAN) and/or a virtualized RAN (VRAN), which may be enabled through at least one respective CU, DU, RU, RRH, and/or remote unit. The base stations 102 may wirelessly communicate with the UEs 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Each of the base stations 102 may provide communication coverage for a respective geographic coverage area 110, which may also be referred to as a “cell.” Potentially, two or more geographic coverage areas 110 may at least partially overlap with one another, or one of the geographic coverage areas 110 may contain another of the geographic coverage areas. For example, the small cell 102′ may have a coverage area 110′ that overlaps with the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use multiple-input and multiple-output (MIMO) antenna technology, including spatial multiplexing, beamforming, and/or transmit diversity. Wireless links or radio links may be on one or more carriers, or component carriers (CCs). The base stations 102 and/or UEs 104 may use spectrum up to Y megahertz (MHz) (e.g., Y may be equal to or approximately equal to 5, 10, 15, 20, 100, 400, etc.) bandwidth per carrier allocated in a carrier aggregation of up to a total of Yx MHz (e.g., x CCs) used for transmission in each direction. The CCs may or may not be adjacent to each other. Allocation of CCs may be asymmetric with respect to downlink and uplink (e.g., more or fewer CCs may be allocated for downlink than for uplink).

The CCs may include a primary CC and one or more secondary CCs. A primary CC may be referred to as a primary cell (PCell) and each secondary CC may be referred to as a secondary cell (SCell). The PCell may also be referred to as a “serving cell” when the UE is known both to a base station at the access network level and to at least one core network entity (e.g., AMF and/or MME) at the core network level, and the UE may be configured to receive downlink control information in the access network (e.g., the UE may be in an RRC Connected state). In some instances in which carrier aggregation is configured for the UE, each of the PCell and the one or more SCells may be a serving cell.

Certain UEs 104 may communicate with each other using device-to-device (D2D) communication link 158. The D2D communication link 158 may use the downlink/uplink WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (or “mmWave” or simply “mmW”) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, the term “sub-6 GHz,” “sub-7 GHz,” and the like, to the extent used herein, may broadly represent frequencies that may be less than 6 GHz, frequencies that may be less than 7 GHz, frequencies that may be within FR1, and/or frequencies that may include mid-band frequencies. Further, unless specifically stated otherwise, the term “millimeter wave” and other similar references, to the extent used herein, may broadly represent frequencies that may include mid-band frequencies, frequencies that may be within FR2, and/or frequencies that may be within the EHF band.

A base station 102, whether a small cell 102′ or a large cell (e.g., macro base station), may include and/or be referred to as an eNB, gNodeB (gNB), or another type of base station. Some base stations 180, such as gNBs, may operate in a traditional sub 6 GHz spectrum, in mmW frequencies, and/or near-mmW frequencies in communication with the UE 104. When such a base station 180 (e.g., gNB) operates in mmW or near-mmW frequencies, the base station 180 may be referred to as a mmW base station. The (mmW) base station 180 may utilize beamforming 186 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182. The UE 104 may receive the beamformed signal from the base station 180 in one or more receive directions 184. The UE 104 may also transmit a beamformed signal to the base station 180 in one or more transmit directions. The base station 180 may receive the beamformed signal from the UE 104 in one or more receive directions. One or both of the base station 180 and/or the UE 104 may perform beam training to determine the best receive and/or transmit directions for the one or both of the base station 180 and/or UE 104. The transmit and receive directions for the base station 180 may or may not be the same. The transmit and receive directions for the UE 104 may or may not be the same.

In various different aspects, one or more of the base stations 102/180 may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. Further, one or more of the base stations 102/180 may be encompassed by the terminology “network node” and/or “network entity.”

In some aspects, one or more of the base stations 102/180 may be connected to the EPC 160 and may provide respective access points to the EPC 160 for one or more of the UEs 104. The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, with the Serving Gateway 166 being connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a Packet Switch (PS) Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

In some other aspects, one or more of the base stations 102/180 may be connected to the core network 190 and may provide respective access points to the core network 190 for one or more of the UEs 104. The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a PS Streaming Service, and/or other IP services.

In certain aspects of the present disclosure, the wireless communications system and an access network 100 may include a non-terrestrial network (NTN). With an NTN, one or more of the base stations 102/180 may be connected with a gateway that may communicate with an NTN payload. For example, the NTN payload may be implemented through a satellite. The NTN payload may provide a feeder link to the gateway connected with a base station 102/180, and some or all connectivity and services available through the base station 102/180 may be provided through the feeder link to the NTN payload. An NTN entity may include any system or device configured to connect with or through an NTN, such as a base station and/or gateway and the like. For example, in one aspect, a base station 102/180 in communication with a UE 104 may be a source NTN entity when the UE 104 is handed over to a target NTN entity, such as the base station 102′/180′.

In certain aspects, the UE 104 may be configured to transmit location information associated with the UE 104 to a source base station 102/180. The UE 104 may be further configured to perform a handover procedure from the source base station 102/180 to a target base station 102′/180′ after transmitting the location information to the source base station 102/180. The UE 104 may be further configured to refrain from transmitting the location information to the target base station 102′/180′ before completion of the handover procedure.

The source base station 102/180 may be configured to receive UE location information associated with the UE 104. The source base station 102/180 may be further configured to transmit a message 198 associated with handover of the UE 104 to a target base station 102′/180′. The message 198 may include information that is based on the UE location information. The source base station 102/180 may be further configured to perform handover of the UE 104.

The target base station 102′/180′ may be configured to receive the message 198 associated with handover of a UE from a source base station 102/180, and the message 198 may indicate the UE location information associated with the UE 104. The target base station 102′/180′ may be further configured to perform handover of the UE 104 without requesting the UE location information from the UE 104.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

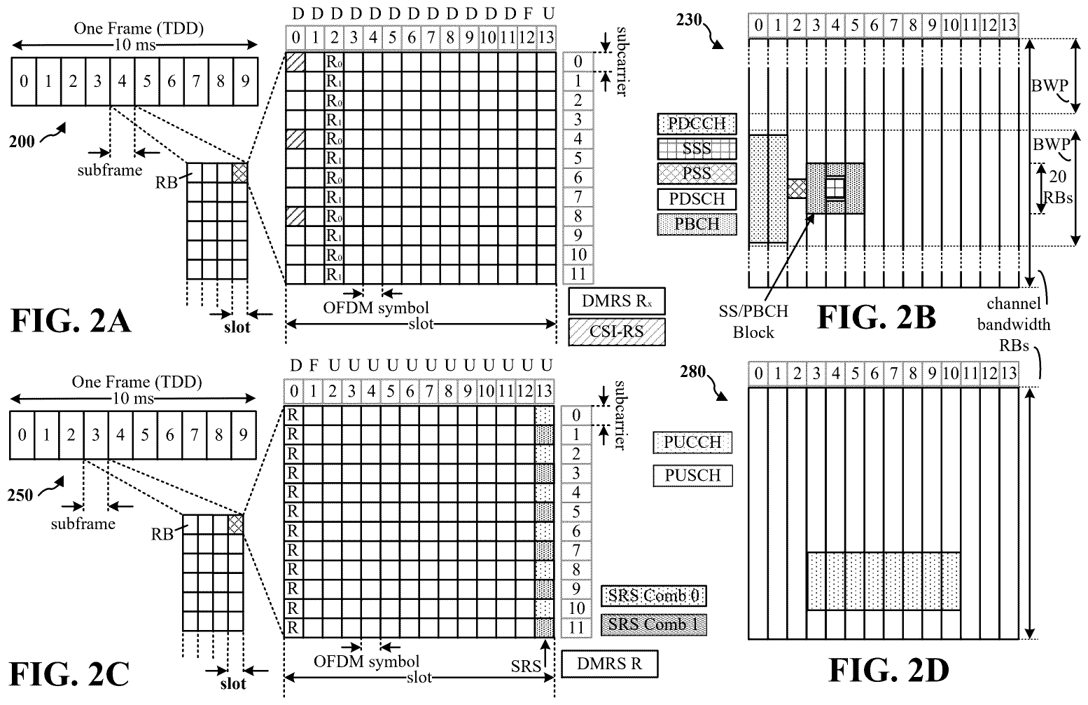

FIG. 2A is a diagram illustrating an example of a first subframe 200 within a 5G NR frame structure. FIG. 2B is a diagram illustrating an example of downlink channels within a 5G NR subframe 230. FIG. 2C is a diagram illustrating an example of a second subframe 250 within a 5G NR frame structure. FIG. 2D is a diagram illustrating an example of uplink channels within a 5G NR subframe 280. The 5G NR frame structure may be frequency division duplexed (FDD) in which for a particular set of subcarriers (carrier system bandwidth), subframes within the set of subcarriers are dedicated for either downlink or uplink, or may be time division duplexed (TDD) in which for a particular set of subcarriers (carrier system bandwidth), subframes within the set of subcarriers are dedicated for both downlink and uplink. In the examples provided by FIGS. 2A, 2C, the 5G NR frame structure is assumed to be TDD, with subframe 4 being configured with slot format 28 (with mostly downlink), where D is downlink, U is uplink, and F is flexible for use between downlink/uplink, and subframe 3 being configured with slot format 34 (with mostly uplink). While subframes 3, 4 are shown with slot formats 34, 28, respectively, any particular subframe may be configured with any of the various available slot formats 0-61. Slot formats 0, 1 are all downlink, uplink, respectively. Other slot formats 2-61 include a mix of downlink, uplink, and flexible symbols. UEs are configured with the slot format (dynamically through downlink control information (DCI), or semi-statically/statically through RRC signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on downlink may be cyclic prefix (CP) orthogonal frequency-division multiplexing (OFDM) (CP-OFDM) symbols. The symbols on uplink may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2allow for 2, 4, and 8 slots, respectively, per subframe. Accordingly, for slot configuration 0 and numerology u, there are 14 symbols/slot and 24 slots/subframe. The subcarrier spacing and symbol length/duration are a function of the numerology. The subcarrier spacing may be equal to 2^{μ}* 15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs). Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry at least one pilot signal, such as a reference signal (RS), for the UE. Broadly, RSs may be used for beam training and management, tracking and positioning, channel estimation, and/or other such purposes. In some configurations, an RS may include at least one demodulation RS (DM-RS) (indicated as Rₓ for one particular configuration, where 100× is the port number, but other DM-RS configurations are possible) and/or at least one channel state information (CSI) RS (CSI-RS) for channel estimation at the UE. In some other configurations, an RS may additionally or alternatively include at least one beam measurement (or management) RS (BRS), at least one beam refinement RS (BRRS), and/or at least one phase tracking RS (PT-RS).

FIG. 2B illustrates an example of various downlink channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. A UE (such as a UE 104 of FIG. 1) may use the PSS to determine subframe/symbol timing and a physical layer identity. A secondary synchronization signal (SSS) may be within symbol 4 of particular subframes of a frame. A UE (such as a UE 104 of FIG. 1) may use the SSS to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the uplink.

FIG. 2D illustrates an example of various uplink channels within a subframe of a frame. The PUCCH may be located as indicated in one configuration. The PUCCH carries uplink control information (UCI), which may include a scheduling request (SR), a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

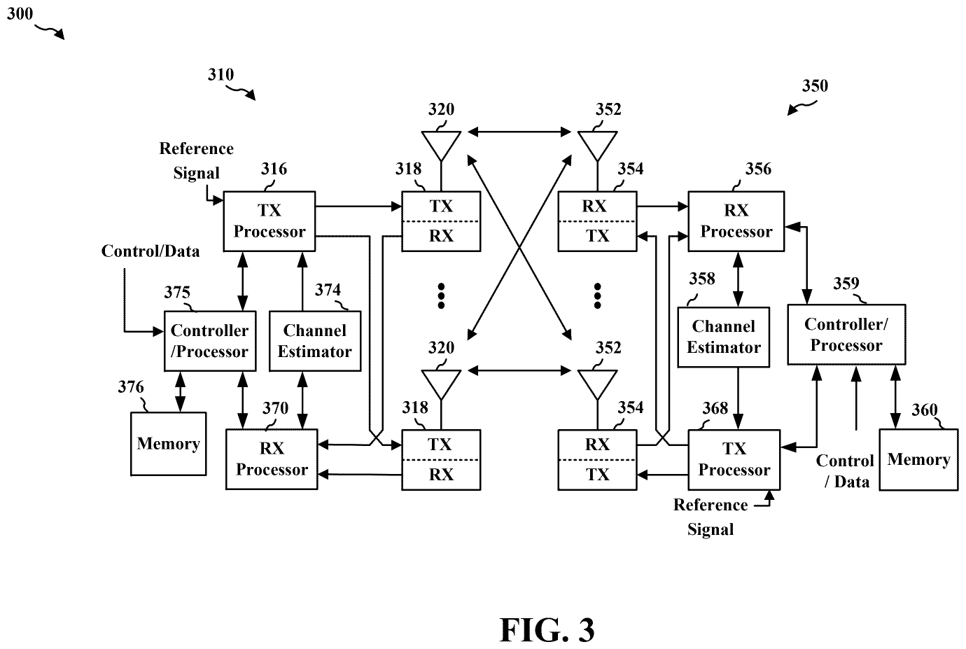

FIG. 3 is a block diagram of a base station 310 in communication with a UE 350 in an access network 300. In the downlink, IP packets from the EPC 160 may be provided to a controller/processor 375. The controller/processor 375 implements Layer 2 (L2) and Layer 3 (L3) functionality. L3 includes an RRC layer, and L2 includes a service data adaptation protocol (SDAP) layer, a packet data convergence protocol (PDCP) layer, an RLC layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement Layer 1 (L1) functionality associated with various signal processing functions. L1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate a radio frequency (RF) carrier with a respective spatial stream for transmission.

At the UE 350, each receiver 354RX receives a signal through at least one respective antenna 352. Each receiver 354RX recovers information modulated onto an RF carrier and provides the information to the receive (RX) processor 356. The TX processor 368 and the RX processor 356 implement L1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements L3 and L2 functionality.

The controller/processor 359 can be associated with a memory 360 that stores program codes and data. The memory 360 may be referred to as a computer-readable medium. In the uplink, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the downlink transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The uplink transmission is processed at the base station 310 in a manner similar to that described in connection with the receiver function at the UE 350. Each receiver 318RX receives a signal through at least one respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the uplink, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

In some aspects, at least one of the TX processor 316, the RX processor 370, and the controller/processor 375 may be configured to perform aspects in connection with the message 198 and UE handover described in FIG. 1.

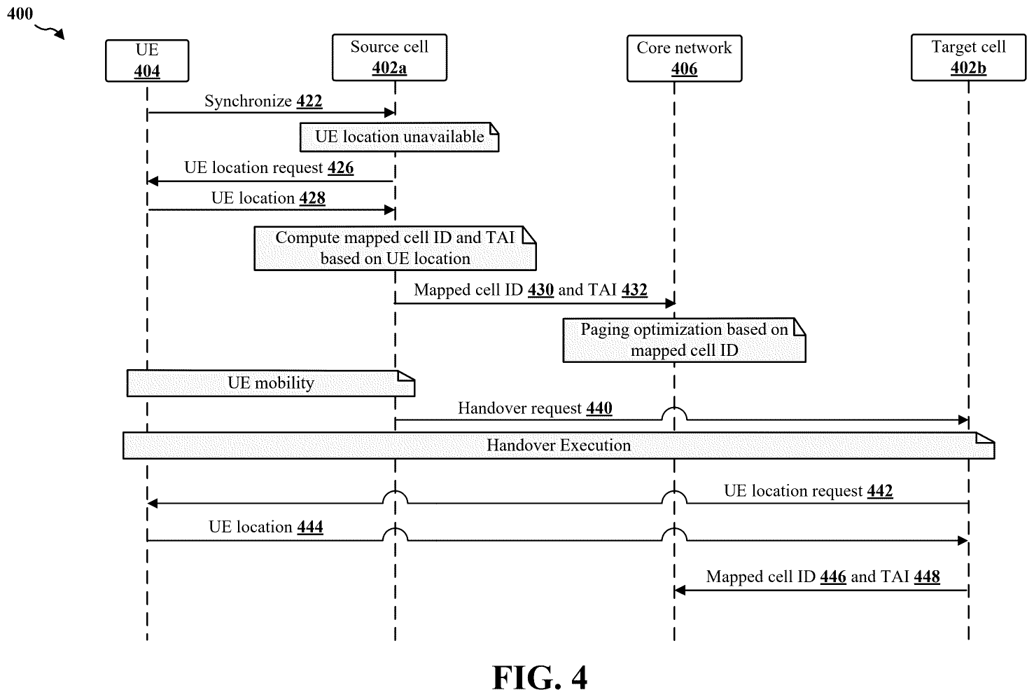

FIG. 4 is a call flow diagram of an example procedure 400 for handover of a UE 404 during NTN-to-NTN mobility. The UE 404 may synchronize 422 with the source cell 402a, such as by acquiring a MIB and/or one or more SIBs transmitted (e.g., broadcasted) in the source cell 402a and/or by performing a RACH procedure with the source cell 402a. At this point, however, the source cell 402a may lack sufficient information to discern the location of the UE 404.

Thus, the source cell 402a may transmit a UE location request 426 to the UE 404. In response to the UE location request 426, the UE 404 may respond with a UE location 428 of the UE 404. Based on the received UE location 428, the source cell 402a may compute a mapped cell ID 430 and a tracking area identifier (TAI) 432. The source cell 402a may transmit the mapped cell ID 430 and the TAI 432 to a core network 406. The core network 406 may use the mapped cell ID 430 and the TAI 432 for paging optimization related to paging the UE 404.

At some point, the UE mobility may occur during which time the UE may be moving outside of the coverage area of the source cell 402a and into the coverage area of the target cell 402b. Accordingly, the source cell 402a may transmit a handover request 440 to the target cell 402b. Based on the handover request 440, the source cell 402a and the target cell 402b may execute a handover procedure of the UE 404 from the source cell 402a to the target cell 402b.

After handover, the target cell 402b may be unaware of the UE location of the UE 404. Therefore, the target cell 402b may transmit a UE location request 442 to the UE 404. The UE 404 may respond to the UE location request 442 with another UE location 444, which may be updated from the earlier UE location 428 due to the UE mobility of the UE 404.

The target cell 402b may receive the UE location 444 and, similarly to the source cell 402a, may compute a mapped cell ID 446 and a TAI 448, which may be updated from the mapped cell ID 430 and TAI 432, respectively, due to the UE mobility. The target cell 402b may transmit the mapped cell ID 446 and the TAI 448 to the core network 406.

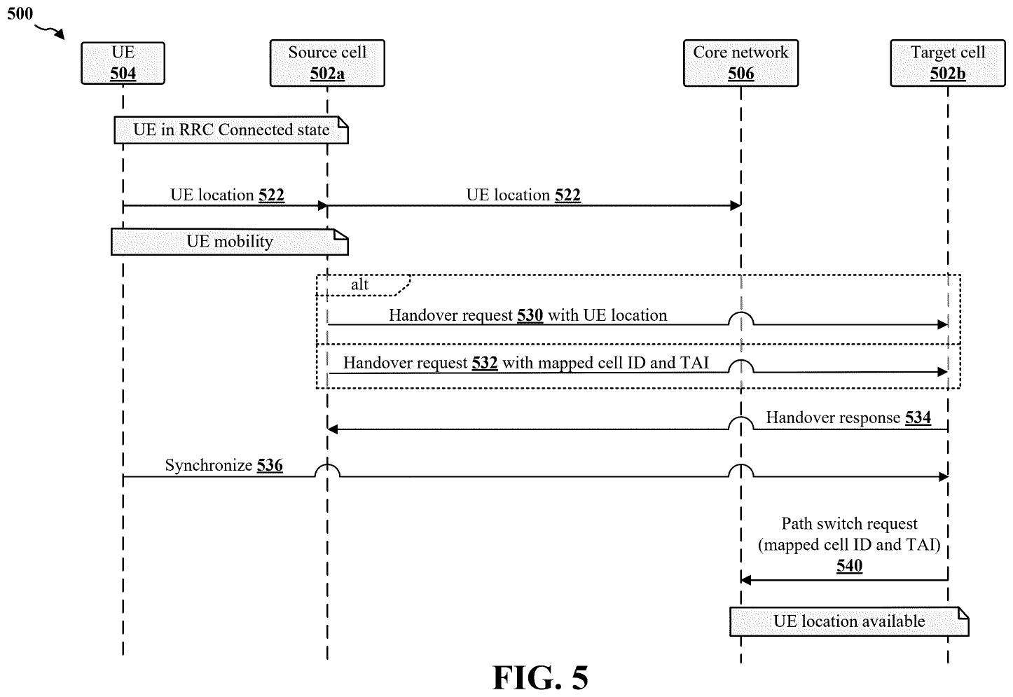

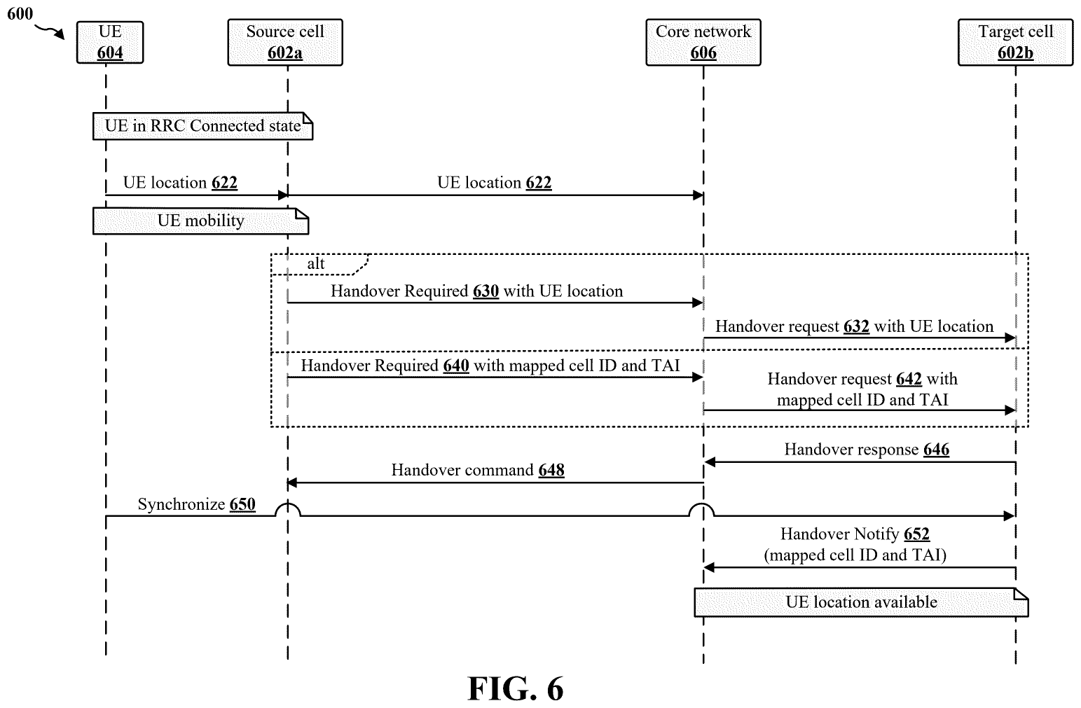

In the context of FIG. 4, when a UE attaches to an NTN cell, the tracking area code (TAC) and paging for the UE may be dependent upon the UE location. Thus, a mapped cell ID and/or TAI for the UE may be sent to a core network by a cell. During UE mobility (e.g., via the Xn interface or the NG interface), the target cell when the UE is handed over may be unaware of the UE location. Consequently, the target cell would be unable to send the mapped cell ID and TAI to the core during handover execution. The target cell would then have to request and receive the UE location from the UE after the handover procedure is complete and send an updated mapped cell ID and/or TAI to the core network. FIG. 5 and FIG. 6 illustrate some alternatives to the example procedure 400 illustrated in FIG. 4, which may be more efficient in terms of signalling and latency.

FIG. 5 is a call flow diagram of another example procedure 500 for handover of a UE 504 during NTN-to-NTN mobility. The UE 504 may be connected to a source cell 502a—e.g., the UE 504 may be operating in an RRC Connected state with the source cell 502a. The UE 504 may transmit a UE location 522 of the UE 504 to the source cell 502a. Further, the source cell 502a may transmit the UE location 522 to the core network 506. UE mobility may occur due to UE movement or NTN cell movement.

This UE mobility may trigger a handover procedure from the source cell 502a to the target cell 502b, which may include the source cell 502a transmitting a handover request to the target cell 502b. In one aspect, the source cell 502a may transmit a handover request 530 that includes the UE location 522. In another aspect, the source cell 502a may transmit a handover request 532 that includes a mapped cell ID and a TAI associated with the UE 504. The target cell 502b may receive the transmitted one of the handover request 530 including the UE location 522 or the handover request 532 including the mapped cell ID and TAI, and therefore, the target cell 502b may be aware of the UE location 522 or the mapped cell ID and TAI, respectively, before the handover procedure is complete and/or without requesting the UE location from the UE 504.

The target cell 502b may transmit a handover response 534 to the source cell 502a. The UE 504 may detach from the source cell 502a and may synchronize 536 with the target cell 502b, such as by performing a RACH procedure (e.g., a contention-free RACH procedure). The target cell 502b may transmit a path switch request 540 associated with the UE 504 to the core network 506. The path switch request 540 may include the mapped cell ID and TAI associated with the UE 504, which may have been received in the handover request 532 or may have been determined (e.g., calculated, computed, etc.) by the target cell 502b based on the UE location 522 included in the handover request 530. Thus, both the target cell 502b and the core network 506 may have sufficient information regarding the location of the UE 504 that the handover procedure can be executed and the UE 504 can be tracked, paged, etc. without the UE 504 transmitting location information and without the target cell 502b may requesting the UE location

FIG. 6 is a call flow diagram of still another example procedure 600 for handover of a UE 604 during NTN-to-NTN mobility. The UE 604 may be connected to a source cell 602a—e.g., the UE 604 may be operating in an RRC Connected state with the source cell 602a. The UE 604 may transmit a UE location 622 of the UE 604 to the source cell 602a. Further, the source cell 602a may transmit the UE location 622 to the core network 606. UE mobility may occur due to UE movement or NTN cell movement.

This UE mobility may trigger a handover procedure from the source cell 602a to the target cell 602b, which may be assisted by the core network 606. Thus, the source cell 602a may transmit a Handover Required message to the core network 606, and based on the Handover Required message, the target cell 602b may receive a handover request from the core network 606.

In some aspects, the source cell 602a may transmit a Handover Required message 630 that includes the UE location 622 to the core network 606. In such aspects, the target cell 602b may receive a handover request 632 that includes the UE location 622 from the core network 606. Accordingly, the target cell 602b may be aware of the UE location 622 of the UE 604 (from which the mapped cell ID and TAI of the UE 604 can be computed) before the handover procedure is complete and/or without requesting the UE location from the UE 604.

In another aspect, the source cell 602a may transmit a Handover Required message 640 that includes a mapped cell ID and a TAI associated with the UE 604 to the core network 606. The target cell 602b may receive a handover request 642 that includes the mapped cell ID and TAI from the core network 606. Accordingly, the target cell 602b may be aware of the mapped cell ID and TAI of the UE 604, respectively, before the handover procedure is complete and/or without requesting the UE location from the UE 604.

The target cell 602b may transmit a handover response 646 to the core network 606. Based on the handover response 646, the source cell 602a may receive a handover command 648 from the core network 606. The UE 604 may detach from the source cell 602a and may synchronize 650 with the target cell 602b, such as by performing a RACH procedure (e.g., a contention-free RACH procedure). The target cell 602b may transmit a Handover Notify message 652 to the core network 606. The Handover Notify message 652 may include the mapped cell ID and TAI associated with the UE 604, which may have been included in the Handover Required message 640 transmitted by the source cell 602a to the core network 606 and included in the handover request 642 received by the target cell 602b from the core network 606. In some aspects in which the Handover Required message 630 and the handover request 632 include the UE location 622 of the UE 604, the target cell 602b may determine (e.g., calculate, compute, etc.) the mapped cell ID and TAI of the UE 604 based on the UE location 622. Thus, both the target cell 602b and the core network 606 may have sufficient information regarding the location of the UE 604 that the handover procedure can be executed and the UE 604 can be tracked, paged, etc. without the UE 604 transmitting location information and without the target cell 602b may requesting the UE location.

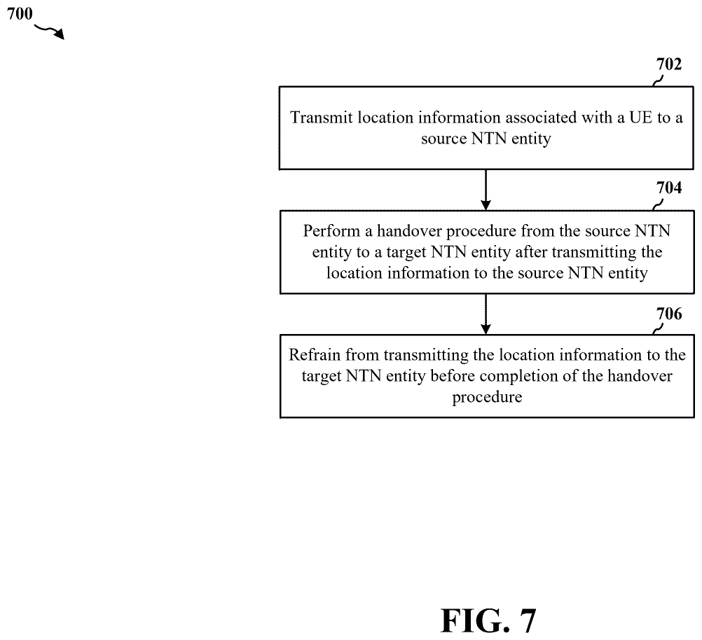

FIG. 7 is a flowchart of a method 700 of wireless communication. The method 700 may be performed by or at a UE (e.g., the UE 104, 350, 504), another wireless communications apparatus, or one or more components thereof. According to various different aspects, one or more of the illustrated blocks of the method 700 may be omitted, transposed, and/or contemporaneously performed.

At operation 702, the UE may be configured to transmit location information associated with the UE to a source NTN entity. In some aspects, the location information includes at least one of UE location, a mapped cell identifier, or a tracking area identifier.

In the context of FIG. 5, operation 702 may be illustrated by the UE 504 transmitting the UE location 522 to the source cell 502a. In the context of FIG. 6, operation 702 may be illustrated by the UE 604 transmitting the UE location 622 to the source cell 602a.

At operation 704, the UE may be configured to perform a handover procedure from the source NTN entity to a target NTN entity after transmitting the location information to the source NTN entity.

In the context of FIG. 5, operation 704 may be illustrated by the UE 504 being handed over from the source cell 502a to the target cell 502b, and the UE 504 may synchronize 536 with the target cell 502b.

In the context of FIG. 6, operation 704 may be illustrated by the UE 604 being handed over from the source cell 602a to the target cell 602b, and the UE 604 may synchronize 650 with the target cell 602b.

At operation 706, the UE may be configured to refrain from transmitting the location information to the target NTN entity before completion of the handover procedure.

In the context of FIG. 5, operation 706 may be illustrated by the UE 504 refraining from transmitting UE location information to the target cell 502b, e.g., upon synchronizing 536 with the target cell 502b after being handed over from the source cell 502a. In the context of FIG. 6, operation 706 may be illustrated by the UE 604 refraining from transmitting UE location information to the target cell 602b, e.g., upon synchronizing 650 with the target cell 602b after being handed over from the source cell 602a.

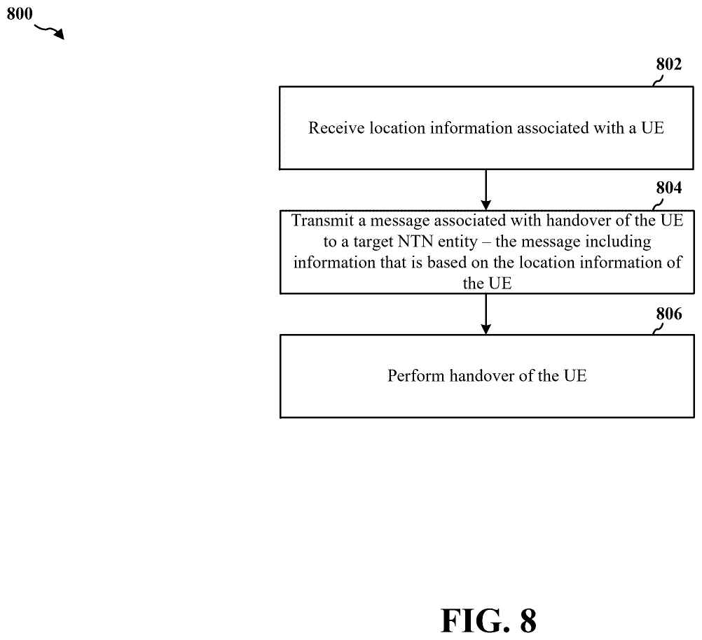

FIG. 8 is a flowchart of a method 800 of wireless communication. The method 800 may be performed by or at a network entity (e.g., the base station 102/180, 310; the source cell 502a, 602a), another wireless communications apparatus, or one or more components thereof. For example, the method 800 may be performed by or at a source NTN entity. According to various different aspects, one or more of the illustrated blocks may be omitted, transposed, and/or contemporaneously performed.

At operation 802, the source NTN entity may be configured to receive location information associated with a UE.

In the context of FIG. 5, operation 802 may be illustrated by the source cell 502a receiving the UE location 522 from the UE 504.

In the context of FIG. 6, operation 802 may be illustrated by the source cell 602a receiving the UE location 622 from the UE 604.

At operation 804, the source NTN entity may be configured to transmit a message associated with handover of the UE to a target NTN entity. The message may include information that is based on the location information associated with the UE. In some aspects, the message includes a handover request transmitted to the target NTN entity over an Xn interface. In some aspects, the message may include a Handover Required message associated with the handover of the UE to the target NTN entity, and source NTN entity may transmit the Handover Required message to a core network entity over an NG interface. In some aspects, the message may be included one of: (1) in a source to target transparent container, or (2) outside of the container for awareness of a UE location at the core network. In some aspects, the information that is based on the location information may include at least one of a UE location, a mapped cell identifier, or a tracking area identifier.

In the context of FIG. 5, operation 804 may be illustrated by the source cell 502a transmitting, to the target cell 502b, one of the handover request 530 with UE location or the handover request 532 with mapped cell ID and tracking area identifier (TAI). a message associated with handover of the UE to a target NTN entity.

In the context of FIG. 6, operation 804 may be illustrated by the source cell 602a transmitting, to the core network 606, one of the Handover Required message 630 with UE location or the Handover Required message 640 with mapped cell ID and TAI.

At operation 806, the source NTN entity may be configured to perform handover of the UE. For example, the source NTN entity may handover the UE to a target NTN entity. In some aspects, the handover may be facilitated by a core network. When performing handover of the UE, the source NTN entity may receive a handover response (e.g., from the target NTN entity when the handover is unassisted by the core network) or a handover command (e.g., from the core network when the handover is assisted by the core network).

In the context of FIG. 5, operation 806 may be illustrated by the source cell 502a performing handover of the UE 504 to the target cell 502b. The source cell 502a may receive a handover response 534 from the target cell 502b, e.g., in response to one of the handover request 530 with UE location or the handover request 532 with mapped cell ID and TAI.

In the context of FIG. 6, operation 806 may be illustrated by the source cell 602a performing handover of the UE 604 to the target cell 602b through the core network 606. The source cell 602a may receive, from the core network 606, the handover command 648 in response to one of the Handover Required message 630 with UE location or the Handover Required message 640 with mapped cell ID and TAI.

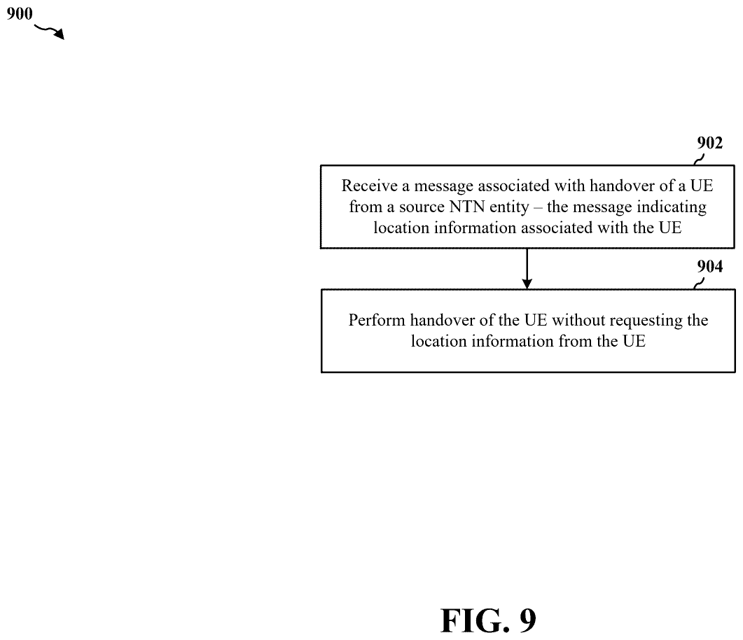

FIG. 9 is a flowchart of a method 900 of wireless communication. The method 900 may be performed by or at a network entity (e.g., the base station 92/180, 310), another wireless communications apparatus, or one or more components thereof. For example, the method 900 may be performed by or at a target NTN entity. According to various different aspects, one or more of the illustrated blocks may be omitted, transposed, and/or contemporaneously performed.

At operation 902, the target NTN entity may be configured to receive a message associated with handover of a UE from a source NTN entity, and the message may indicate location information associated with the UE. In some aspects, the message includes a handover request received from the source NTN entity over an Xn interface. In some aspects, the message includes a handover request message associated with the handover of the UE from the source NTN entity, and the handover required message may be received from a core network entity over an NG interface. In some aspects, the message may be included one of: (1) in a source to target transparent container, or (2) outside of the container for awareness of a UE location at the core network. In some aspects, the location information includes at least one of a UE location, a mapped cell identifier, or a tracking area identifier.

In the context of FIG. 5, operation 902 may be illustrated by the target cell 502b receiving a message associated with handover of the UE 504 from the source cell 502a. The message may be a handover request 530, received from the source cell 502a, that includes the UE location 522, or the message may be a handover request 532, received from the source cell 502a, that includes a mapped cell ID and a TAI associated with the UE 504. In the context of FIG. 6, operation 902 may be illustrated by the target cell 602b receiving, from the core network 606, the handover request 632 or the handover request 642 that indicates at least one of the UE location 622, a mapped cell ID, or a TAI associated with the UE 604.

At operation 904, the target NTN entity may be configured to perform handover of the UE without requesting the location information from the UE. For example, the target NTN entity may be configured to transmit a handover response based on a received handover request.

In some aspects, the target NTN entity may be further configured to: calculate at least one of the mapped cell identifier or the TAI based on the location information associated with the UE; and transmit a handover notification to the core network entity that indicates the at least one of the mapped cell identifier or the tracking area identifier. The target NTN entity may therefore have the location of the UE without receiving an indication of the UE location from the UE after the handover procedure of the UE.

In the context of FIG. 5, operation 904 may be illustrated by the target cell 502b performing handover of the UE 504 from the source cell 502a 5. The target cell 502b may transmit a handover response to the source cell 502a based on the handover request 530 that includes the UE location 522 or the handover request 532 that includes a mapped cell ID and a TAI associated with the UE 504. Further, the target cell 502b may transmit a path switch request 540 including the mapped cell ID and TAI to the core network 506. In the context of FIG. 6, operation 904 may be illustrated by the target cell 602b transmitting, to the core network 606, the handover response 646 and the Handover Notify message 652 that includes the mapped cell ID and/or the TAI for the UE 604.

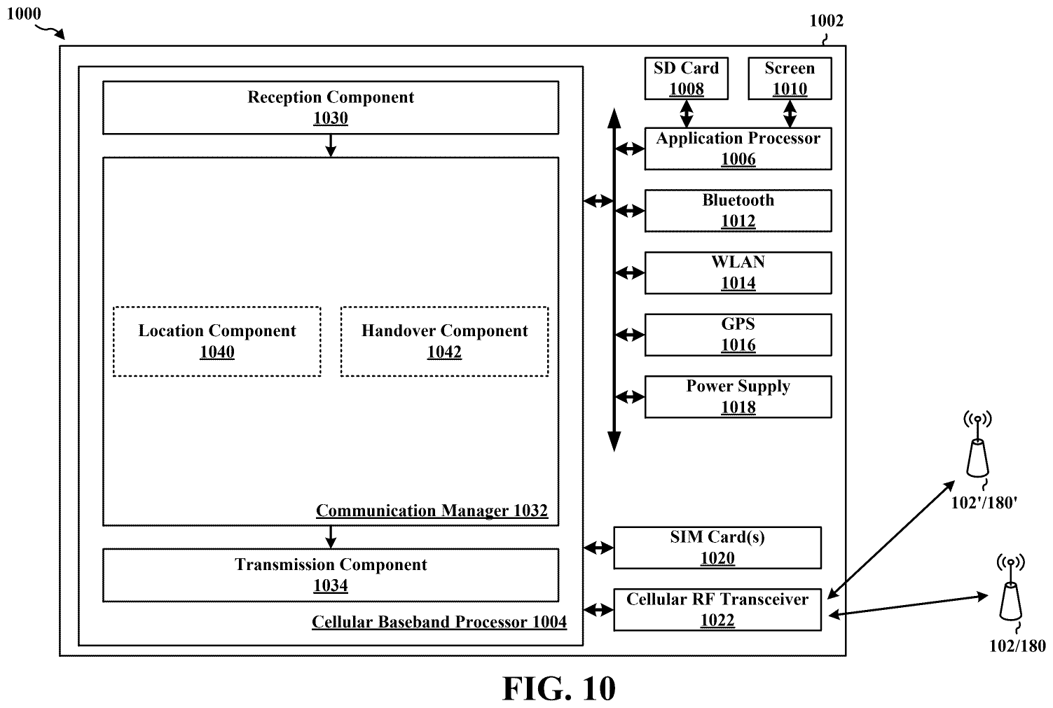

FIG. 10 is a diagram 1000 illustrating an example of a hardware implementation for an apparatus 1002. The apparatus 1002 may be a UE or similar device, or the apparatus 1002 may be a component of a UE or similar device. The apparatus 1002 may include a cellular baseband processor 1004 (also referred to as a modem) and/or a cellular RF transceiver 1022, which may be coupled together and/or integrated into the same package, component, circuit, chip, and/or other circuitry.

In some aspects, the apparatus 1002 may accept or may include one or more subscriber identity modules (SIM) cards 1020, which may include one or more integrated circuits, chips, or similar circuitry, and which may be removable or embedded. The one or more SIM cards 1020 may carry identification and/or authentication information, such as an international mobile subscriber identity (IMSI) and/or IMSI-related key(s). Further, the apparatus 1002 may include one or more of an application processor 1006 coupled to a secure digital (SD) card 1008 and a screen 1010, a Bluetooth module 1012, a wireless local area network (WLAN) module 1014, a Global Positioning System (GPS) module 1016, and/or a power supply 1018.

The cellular baseband processor 1004 communicates through the cellular RF transceiver 1022 with the UE 104 and/or base station 102/180. The cellular baseband processor 1004 may include a computer-readable medium/memory. The computer-readable medium/memory may be non-transitory. The cellular baseband processor 1004 is responsible for general processing, including the execution of software stored on the computer-readable medium/memory. The software, when executed by the cellular baseband processor 1004, causes the cellular baseband processor 1004 to perform the various functions described supra. The computer-readable medium/memory may also be used for storing data that is manipulated by the cellular baseband processor 1004 when executing software. The cellular baseband processor 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the cellular baseband processor 1004.

In the context of FIG. 3, the cellular baseband processor 1004 may be a component of the UE 350 and may include the memory 360 and/or at least one of the TX processor 368, the RX processor 356, and/or the controller/processor 359. In one configuration, the apparatus 1002 may be a modem chip and/or may be implemented as the baseband processor 1004, while in another configuration, the apparatus 1002 may be the entire UE (e.g., the UE 350 of FIG. 3) and may include some or all of the abovementioned components, circuits, chips, and/or other circuitry illustrated in the context of the apparatus 1002. In one configuration, the cellular RF transceiver 1022 may be implemented as at least one of the transmitter 354TX and/or the receiver 354RX.

The reception component 1030 may be configured to receive signaling on a wireless channel, such as signaling from a base station 102/180 or UE 104. The transmission component 1034 may be configured to transmit signaling on a wireless channel, such as signaling to a base station 102/180 or UE 104. The communication manager 1032 may coordinate or manage some or all wireless communications by the apparatus 1002, including across the reception component 1030 and the transmission component 1034.

The reception component 1030 may provide some or all data and/or control information included in received signaling to the communication manager 1032, and the communication manager 1032 may generate and provide some or all of the data and/or control information to be included in transmitted signaling to the transmission component 1034. The communication manager 1032 may include the various illustrated components, including one or more components configured to process received data and/or control information, and/or one or more components configured to generate data and/or control information for transmission.

The communication manager 1032 may include a location component 1040 and a handover component 1042. The location component 1040 may be configured to determine a location (e.g., a geographic location) of the apparatus 1002. The transmission component 1034 may be configured to transmit location information associated with the apparatus 1002 to a source NTN entity 102/180, e.g., as described in connection with 702 of FIG. 7. In some aspects, the location information includes at least one of UE location, a mapped cell identifier, or a tracking area identifier.

The handover component 1042 may be configured to perform a handover procedure from the source NTN entity 102/180 to a target NTN entity 102′/180′ after transmitting the location information to the source NTN entity 102/180, e.g., as described in connection with 704 of FIG. 7.

The transmission component 1034 may be configured to refrain from transmitting the location information to the target NTN entity 102′/180′ before completion of the handover procedure, e.g., as described in connection with 706 of FIG. 7.

The apparatus 1002 may include additional components that perform some or all of the blocks, operations, signaling, etc. of the algorithm(s) in the aforementioned call flow diagram(s) and/or flowchart(s) of FIG(S). 4-7. As such, some or all of the blocks, operations, signaling, etc. in the aforementioned call flow diagram(s) and/or flowchart(s) of FIG(S). 4-7 may be performed by one or more components and the apparatus 1002 may include one or more such components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1002, and in particular the cellular baseband processor 1004, includes means for transmitting location information associated with the UE to a source NTN entity; means for performing a handover procedure from the source NTN entity to a target NTN entity after transmitting the location information to the source NTN entity; and means for refraining from transmitting the location information to the target NTN entity before completion of the handover procedure.

In one configuration, the location information comprises at least one of UE location, a mapped cell identifier, or a tracking area identifier.

The aforementioned means may be one or more of the aforementioned components of the apparatus 1002 configured to perform the functions recited by the aforementioned means. As described supra, the apparatus 1002 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

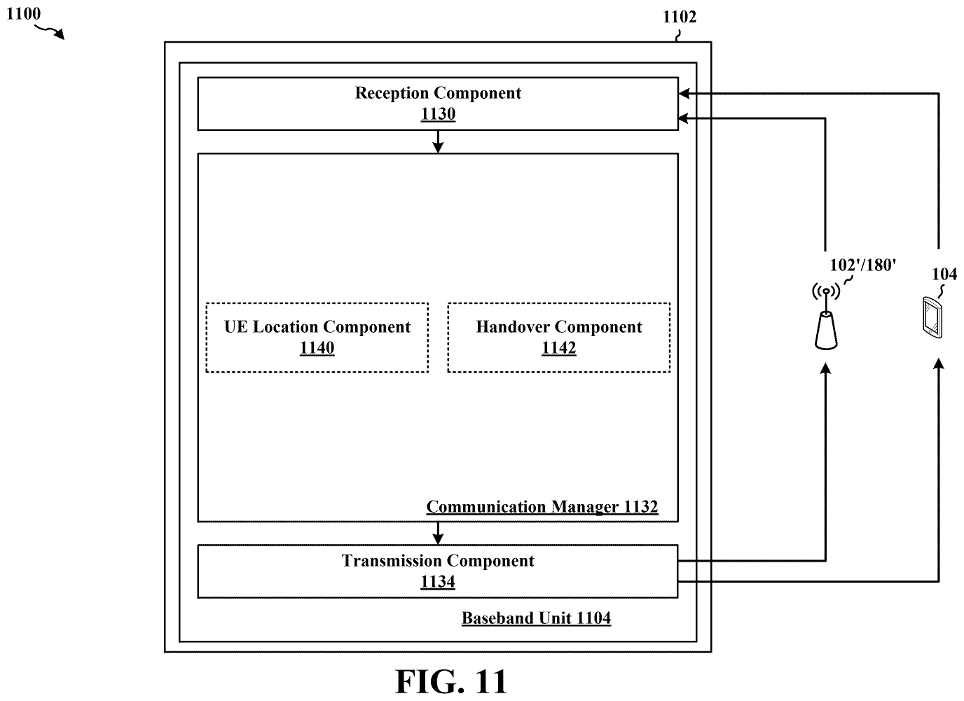

FIG. 11 is a diagram 1100 illustrating an example of a hardware implementation for an apparatus 1102. The apparatus 1102 may be a base station or similar device or system, or the apparatus 1102 may be a component of a base station or similar device or system. The apparatus 1102 may include a baseband unit 1104. The baseband unit 1104 may communicate through a cellular RF transceiver. For example, the baseband unit 1104 may communicate through a cellular RF transceiver with a UE 104, such as for downlink and/or uplink communication, and/or with a base station 102/180, such as for IAB.

The baseband unit 1104 may include a computer-readable medium/memory, which may be non-transitory. The baseband unit 1104 is responsible for general processing, including the execution of software stored on the computer-readable medium/memory. The software, when executed by the baseband unit 1104, causes the baseband unit 1104 to perform the various functions described supra. The computer-readable medium/memory may also be used for storing data that is manipulated by the baseband unit 1104 when executing software. The baseband unit 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the baseband unit 1104. The baseband unit 1104 may be a component of the base station 310 and may include the memory 376 and/or at least one of the TX processor 316, the RX processor 370, and the controller/processor 375.

The reception component 1130 may be configured to receive signaling on a wireless channel, such as signaling from a UE 104 or base station 102/180. The transmission component 1134 may be configured to transmit signaling on a wireless channel, such as signaling to a UE 104 or base station 102/180. The communication manager 1132 may coordinate or manage some or all wireless communications by the apparatus 1102, including across the reception component 1130 and the transmission component 1134.

The reception component 1130 may provide some or all data and/or control information included in received signaling to the communication manager 1132, and the communication manager 1132 may generate and provide some or all of the data and/or control information to be included in transmitted signaling to the transmission component 1134. The communication manager 1132 may include the various illustrated components, including one or more components configured to process received data and/or control information, and/or one or more components configured to generate data and/or control information for transmission. In some aspects, the generation of data and/or control information may include packetizing or otherwise reformatting data and/or control information received from a core network, such as the core network 190 or the EPC 160, for transmission.

The communication manager 1132 may include a UE location component 1140 and a handover component 1142. The reception component 1130 may be configured to receive location information associated with a UE 104, e.g., as described in connection with 802 of FIG. 8.

The transmission component 1134 may be configured to transmit a message associated with handover of the UE 104 to a target NTN entity 102′/180′, e.g., as described in connection with 804 of FIG. 8. The UE location component 1140 may derive the location of the UE 104 from the received location information, and the location component 1140 may generate the message associated with handover of the UE 104 such that the message may include information that is based on the location information associated with the UE 104.

In some aspects, the message includes a handover request transmitted to the target NTN entity 102′/180′ over an Xn interface. In some aspects, the message may include a Handover Required message associated with the handover of the UE 104 to the target NTN entity 102′/180′, and transmission component 1134 may transmit the Handover Required message to a core network entity over an NG interface. In some aspects, the message may be included one of: in a source to target transparent container or outside of the container for awareness of a UE location at the core network. In some aspects, the information that is based on the location information may include at least one of a UE location, a mapped cell identifier, or a tracking area identifier.

The handover component 1142 may be configured to perform handover of the UE 104. For example, the source NTN entity may handover the UE 104 to a target NTN entity 102′/180′. In some aspects, the handover may be facilitated by a core network. When performing handover of the UE 104, the handover component 1142 may receive a handover response (e.g., from the target NTN entity 102′/180′ when the handover is unassisted by the core network) or a handover command (e.g., from the core network when the handover is assisted by the core network).

The apparatus 1102 may include additional components that perform some or all of the blocks, operations, signaling, etc. of the algorithm(s) in the aforementioned call flow diagram(s) and/or flowchart(s) of FIG(S). 4-6 and/or 8. As such, some or all of the blocks, operations, signaling, etc. in the aforementioned call flow diagram(s) and/or flowchart(s) of FIG(S). 4-6 and/or 8 may be performed by a component and the apparatus 1102 may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1102, and in particular the baseband unit 1104, includes means for receiving UE location information associated with a UE; and means for transmitting a message associated with handover of the UE to a target NTN entity, and the message includes information that is based on the UE location information for handover of the UE.

In one configuration, the message includes a handover request transmitted to the target NTN entity over an Xn interface.

In one configuration, the message includes a handover required message associated with the handover of the UE to the target NTN entity, and the handover required message is transmitted to a core network entity over an NG interface.

In one configuration, the message includes the UE location information one of in a source to target transparent container or outside of the container for awareness of a UE location at the core network.

In one configuration, information that is based on the location information comprises at least one of a UE location, a mapped cell identifier, or a tracking area identifier.

The aforementioned means may be one or more of the aforementioned components of the apparatus 1102 configured to perform the functions recited by the aforementioned means. As described supra, the apparatus 1102 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

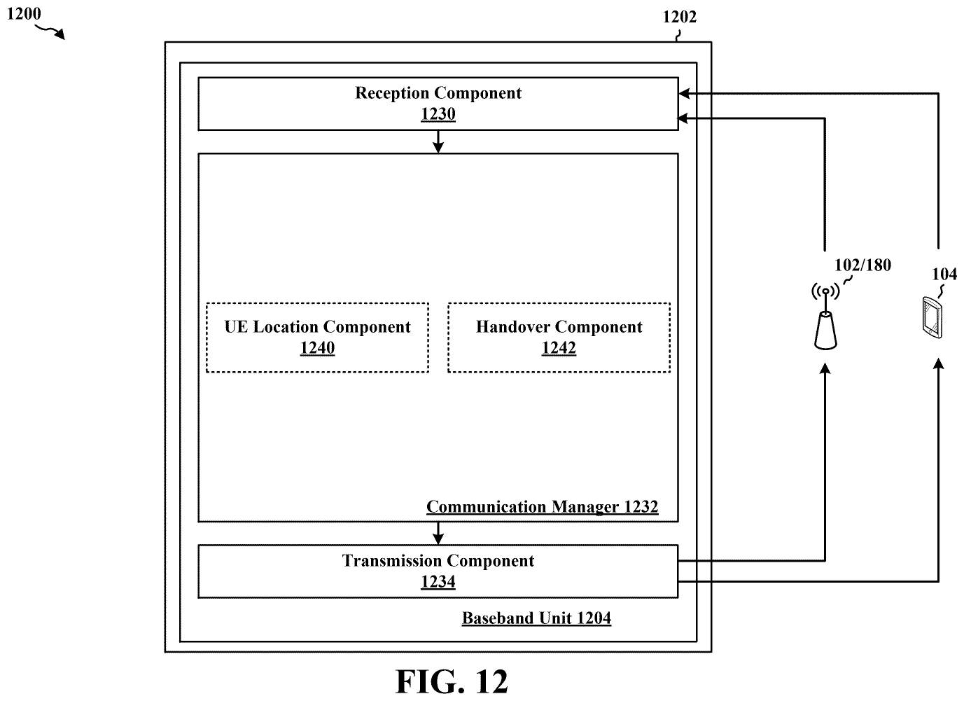

FIG. 12 is a diagram 1200 illustrating an example of a hardware implementation for an apparatus 1202. The apparatus 1202 may be a base station or similar device or system, or the apparatus 1202 may be a component of a base station or similar device or system. The apparatus 1202 may include a baseband unit 1204. The baseband unit 1204 may communicate through a cellular RF transceiver. For example, the baseband unit 1204 may communicate through a cellular RF transceiver with a UE 104, such as for downlink and/or uplink communication, and/or with a base station 102/180, such as for IAB.

The baseband unit 1204 may include a computer-readable medium/memory, which may be non-transitory. The baseband unit 1204 is responsible for general processing, including the execution of software stored on the computer-readable medium/memory. The software, when executed by the baseband unit 1204, causes the baseband unit 1204 to perform the various functions described supra. The computer-readable medium/memory may also be used for storing data that is manipulated by the baseband unit 1204 when executing software. The baseband unit 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the baseband unit 1204. The baseband unit 1204 may be a component of the base station 310 and may include the memory 376 and/or at least one of the TX processor 316, the RX processor 370, and the controller/processor 375.

The reception component 1230 may be configured to receive signaling on a wireless channel, such as signaling from a UE 104 or base station 102/180. The transmission component 1234 may be configured to transmit signaling on a wireless channel, such as signaling to a UE 104 or base station 102/180. The communication manager 1232 may coordinate or manage some or all wireless communications by the apparatus 1202, including across the reception component 1230 and the transmission component 1234.

The reception component 1230 may provide some or all data and/or control information included in received signaling to the communication manager 1232, and the communication manager 1232 may generate and provide some or all of the data and/or control information to be included in transmitted signaling to the transmission component 1234. The communication manager 1232 may include the various illustrated components, including one or more components configured to process received data and/or control information, and/or one or more components configured to generate data and/or control information for transmission. In some aspects, the generation of data and/or control information may include packetizing or otherwise reformatting data and/or control information received from a core network, such as the core network 190 or the EPC 160, for transmission.

The communication manager 1232 includes a UE location component 1240 and a handover component 1242. The reception component 1230 may be configured to receive a message associated with handover of a UE 104 from a source NTN entity 102/180, and the message may indicate location information associated with the UE, e.g., as described in connection with 902 of FIG. 9. The UE location component 1240 may derive a location (e.g., a geographic position) of the UE 104 from the received message. In some aspects, the message includes a handover request received from the source NTN entity 102/180 over an Xn interface. In some aspects, the message includes a handover request message associated with the handover of the UE 104 from the source NTN entity 102/180, and the handover required message may be received from a core network entity over an NG interface. In some aspects, the message may be included one of in a source to target transparent container or outside of the container for awareness of a UE location at the core network. In some aspects, the location information includes at least one of a UE location, a mapped cell identifier, or a tracking area identifier.

The handover component 1242 may be configured to perform handover of the UE 104 without requesting the location information from the UE 104, e.g., as described in connection with 904 of FIG. 9. For example, the handover component 1242 may be configured to transmit a handover response based on a received handover request.

In some aspects, the UE location component 1240 may be further configured to calculate at least one of the mapped cell identifier or the TAI based on the location information associated with the UE; and the handover component 1242 may be further configured to transmit a handover notification to the core network entity that indicates the at least one of the mapped cell identifier or the tracking area identifier. The UE location component 1240 may therefore have the location of the UE 104 without receiving an indication of the UE location from the UE 104 after the handover procedure of the UE 104.

The apparatus 1202 may include additional components that perform some or all of the blocks, operations, signaling, etc. of the algorithm(s) in the aforementioned call flow diagram(s) and/or flowchart(s) of FIG(S). 4-6 and/or 9. As such, some or all of the blocks, operations, signaling, etc. in the aforementioned call flow diagram(s) and/or flowchart(s) of FIG(S). 4-6 and/or 9 may be performed by a component and the apparatus 1202 may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1202, and in particular the baseband unit 1204, includes means for receiving a message associated with handover of a UE from a source NTN entity, and the message indicates UE location information associated with the UE; and means for performing handover of the UE without requesting the UE location information from the UE.

In one configuration, the message includes a handover request received from the source NTN entity over an Xn interface.

In one configuration, the message includes a handover request message associated with the handover of the UE from the source NTN entity, and the handover request message is received from a core network entity over an NG interface.

In one configuration, the message includes the UE location information one of in a source to target transparent container or outside of the container for awareness of a UE location at the core network.

In one configuration, the UE location information includes at least one of a UE location, a mapped cell identifier, or a tracking area identifier.

In one configuration, the apparatus 1202, and in particular the baseband unit 1204, may further include means for calculating at least one of the mapped cell identifier or the tracking area identifier based on the UE location information associated with the UE received during handover preparation; and means for transmitting a handover notification to the core network entity that indicates the at least one of the mapped cell identifier or the tracking area identifier.

The aforementioned means may be one or more of the aforementioned components of the apparatus 1202 configured to perform the functions recited by the aforementioned means. As described supra, the apparatus 1202 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

The specific order or hierarchy of blocks or operations in each of the foregoing processes, flowcharts, and other diagrams disclosed herein is an illustration of example approaches. Based upon design preferences, the specific order or hierarchy of blocks or operations in each of the processes, flowcharts, and other diagrams may be rearranged, omitted, and/or contemporaneously performed without departing from the scope of the present disclosure. Further, some blocks or operations may be combined or omitted. The accompanying method claims present elements of the various blocks or operations in a sample order, and are not meant to be limited to the specific order or hierarchy presented.

The following examples are illustrative only and may be combined with aspects of other embodiments or teachings described herein, without limitation.

Example 1 is an apparatus at a UE that is configured for: transmitting location information associated with the UE to a source NTN entity; performing a handover procedure from the source NTN entity to a target NTN entity after transmitting the location information to the source NTN entity; and refraining from transmitting the location information to the target NTN entity before completion of the handover procedure.

Example 2 may be the apparatus of Example 1, and the location information includes at least one of UE location, a mapped cell identifier, or a tracking area identifier.

Example 3 is an apparatus at a source NTN entity that is configured for: receiving UE location information associated with a UE; transmitting a message associated with handover of the UE to a target NTN entity, and the message includes information that is based on the UE location information; and performing handover of the UE.

Example 4 may be the apparatus of Example 3, and the message includes a handover request transmitted to the target NTN entity over an Xn interface.

Example 5 may be the apparatus of Example 3, and the message includes a handover required message associated with the handover of the UE to the target NTN entity, and the handover required message is transmitted to a core network entity over an NG interface.

Example 6 may be the apparatus of Example 5, and the message includes the UE location information one of: in a source to target transparent container or outside of the container for awareness of a UE location at the core network.

Example 7 may be the apparatus of Example 3, and information that is based on the UE location information includes at least one of a UE location, a mapped cell identifier, or a tracking area identifier.

Example 8 is an apparatus at a target NTN entity that is configured for: receiving a message associated with handover of a UE from a source NTN entity, and the message indicates UE location information associated with the UE; and performing handover of the UE without requesting the UE location information from the UE.

Example 9 may be the apparatus of Example 8, and the message includes a handover request received from the source NTN entity over an Xn interface.

Example 10 may be the apparatus of Example 8, and the message includes a handover request message associated with the handover of the UE from the source NTN entity, and the handover request message is received from a core network entity over an NG interface.

Example 11 may be the apparatus of Example 10, and the message includes the UE location information one of: in a source to target transparent container or outside of the container for awareness of a UE location at the core network.

Example 12 may be the apparatus of Example 10, and the UE location information includes at least one of a UE location, a mapped cell identifier, or a tracking area identifier.

Example 13 may be the apparatus of Example 12, and being further configured for: calculating at least one of the mapped cell identifier or the tracking area identifier based on the UE location information associated with the UE received during handover preparation; and transmitting a handover notification to the core network entity that indicates the at least one of the mapped cell identifier or the tracking area identifier.

The previous description is provided to enable one of ordinary skill in the art to practice the various aspects described herein. Various modifications to these aspects will be readily apparent to those having ordinary skill in the art, and the generic principles defined herein may be applied to other aspects. Thus, the claims are not intended to be limited to the aspects shown herein, but is to be accorded the full scope consistent with the language. Thus, the language employed herein is not intended to limit the scope of the claims to only those aspects shown herein, but is to be accorded the full scope consistent with the language of the claims.

As one example, the language “determining” may encompass a wide variety of actions, and so may not be limited to the concepts and aspects explicitly described or illustrated by the present disclosure. In some contexts, “determining” may include calculating, computing, processing, measuring, deriving, investigating, looking up (e.g., looking up in a table, a database or another data structure), ascertaining, resolving, selecting, choosing, establishing, and so forth. In some other contexts, “determining” may include communication and/or memory operations/procedures through which information or value(s) are acquired, such as “receiving” (e.g., receiving information), “accessing” (e.g., accessing data in a memory), “detecting,” and the like.

As another example, reference to an element in the singular is not intended to mean “one and only one” unless specifically stated, but rather “one or more.” Further, terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action or event, but rather imply that if a condition is met then another action or event will occur, but without requiring a specific or immediate time constraint or direct correlation for the other action or event to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1-42. (canceled)

43. A method of wireless communication at a user equipment (UE), comprising:
transmitting location information associated with the UE to a source non-terrestrial network (NTN) entity;
performing a handover procedure from the source NTN entity to a target NTN entity after transmitting the location information to the source NTN entity; and
refraining from transmitting the location information to the target NTN entity before completion of the handover procedure.

44. The method of claim 43, wherein the location information comprises a UE location.

45. The method of claim 43, wherein the location information comprises a mapped cell identifier.

46. The method of claim 43, wherein the location information comprises a tracking area identifier.

47. An apparatus for wireless communication at a user equipment (UE), comprising:
a memory; and
at least one processor coupled to the memory and configured to:
transmit location information associated with the UE to a source non-terrestrial network (NTN) entity;
perform a handover procedure from the source NTN entity to a target NTN entity after transmitting the location information to the source NTN entity; and
refrain from transmitting the location information to the target NTN entity before completion of the handover procedure.

48. The apparatus of claim 47, wherein the location information comprises at least one of UE location, a mapped cell identifier, or a tracking area identifier.

49. An apparatus for wireless communication at a source non-terrestrial network (NTN) entity, comprising:
a memory; and
at least one processor coupled to the memory and configured to:
receive user equipment (UE) location information associated with a UE;
transmit a message associated with handover of the UE to a target NTN entity, wherein the message includes information that is based on the UE location information; and
perform handover of the UE.

50. The apparatus of claim 49, wherein the message comprises a handover request transmitted to the target NTN entity over an Xn interface.

51. The apparatus of claim 49, wherein the message comprises a handover required message associated with the handover of the UE to the target NTN entity, wherein the handover required message is transmitted to a core network entity over an NG interface.

52. The apparatus of claim 51, wherein the message includes the UE location information in a source to target transparent container.

53. The apparatus of claim 49, wherein information that is based on the UE location information comprises at least one of a UE location, a mapped cell identifier, or a tracking area identifier.

54. An apparatus for wireless communication at a target non-terrestrial network (NTN) entity, comprising:
a memory; and
at least one processor coupled to the memory and configured to:
receive a message associated with handover of a user equipment (UE) from a source NTN entity, wherein the message indicates UE location information associated with the UE; and
perform handover of the UE without requesting the UE location information from the UE.

55. The apparatus of claim 54, wherein the message comprises a handover request received from the source NTN entity over an Xn interface.

56. The apparatus of claim 54, wherein the message comprises a handover required message associated with the handover of the UE from the source NTN entity, wherein the handover request required is received from a core network entity over an NG interface.

57. The apparatus of claim 56, wherein the message includes the UE location information being in a source to target transparent container for awareness of a UE location at the core network.

58. The apparatus of claim 56, wherein the message includes the UE location information being outside of a container for awareness of a UE location at the core network.

59. The apparatus of claim 56, wherein the UE location information comprises a UE location.

60. The apparatus of claim 56, wherein the UE location information comprises a mapped cell identifier.

61. The apparatus of claim 56, wherein the UE location information comprises a tracking area identifier.

62. The apparatus of claim 56, wherein the at least one processor is further configured to:
calculate at least one of a mapped cell identifier or a tracking area identifier based on the UE location information associated with the UE received during handover preparation; and
transmit a handover notification to the core network entity that indicates the at least one of the mapped cell identifier or the tracking area identifier.
